(19) United States
(12) Patent Application Publication
(10) Pub. No.: US 2016/0228731 A1
(43) Pub. Date: Aug. 11, 2016

(54) Non-Breathing Alarm for Self-Contained-Breathing-Apparatus (SCBA)

(71) Applicant: Eric Sacknoff, Rockville Centre, NY (US)

(72) Inventor: Eric Sacknoff, Rockville Centre, NY (US)

(21) Appl. No.: 14/616,701

(22) Filed: Feb. 7, 2015

(51) Int. Cl. A62B 9/00; A62B 18/02; A62B 9/04; A62B 9/02

(52) U.S. Cl. CPC A62B 9/006; A62B 9/02; A62B 18/02; A62B 9/04

(57) ABSTRACT

The current invention is system and device for a Self-Contained-Breathing-Apparatus (SCBA) emergency situation to solve the problem where a user is motionless and non-breathing. In order to hasten a Full Alarm activation and speed up the notification of distress to rescuers, in addition to the standard motion-sensing alarm, the SCBA shall be equipped with an ‘air activation’ alarm. Such ‘air activation’ alarm system shall monitor airflow to and from the user and activate if a user is not breathing.

### CROSS-REFERENCES TO RELATED APPLICATIONS

None

### STATEMENT AS TO RIGHTS TO INVENTIONS MADE UNDER FEDERALLY SPONSORED RESEARCH AND DEVELOPMENT

None

### FIELD OF THE INVENTION

This device refers to the field of Self-Contained-Breathing-Apparatus (SCBA) more specifically one that has a Non-Breathing Alarm.

### BACKGROUND OF THE INVENTION

Self-Contained-Breathing-Apparatus (SCBA)s have been used for a number of years by Firefighters, First Responders and personnel dealing with bio or chemical hazards.

The NFPA (National Fire Protection Association) is one of many independent, non-profit, Standards writing organizations. NFPA is dominant in the field and while the standards have no legal stature, they are accepted and referenced in court cases.

NFPA Standard 1982 is for a Firefighter's integrated PASS (Personal Alert Safety System) that is incorporated within the Firefighter's air pack, SCBA (self contained breathing apparatus).

The integrated PASS Alarm automatically turns on when the Firefighter opens the air supply valve on his air cylinder. The PASS Alarm will activate for three circumstances:

1) if a Firefighter is out of air;

2) If a Firefighter is motionless for a set amount of time; and

3) if a Firefighter manually sets off an alarm.

This invention relates to the field of Breathing Apparatus, and specifically to Self-Contained-Breathing-Apparatus (SCBA). SCBAs are commonly used by Firefighters and other First Responders to operate in smoke filled and/or Oxygen deficient and/or bio or chemical or radiologically exposed hazardous environments. SCBA will be required in any environment that endangers the respiratory or other bodily systems.

In the industry, most SCBA are equipped with a motion sensing alarm mechanism which constantly monitors movement, or lack thereof, and after a prolonged period without motion could be an indicative of a user in distress. Such alarming mechanisms will usually function by producing some kind of pre-alarm warning, for which after a set amount of motionlessness the user can move and discontinue the sequence. Such alarming mechanism will go into a ‘Full Alarm’ mode if the user has not moved during the pre-alarm cycle. This is to account for a legitimate Alarm activation, such as where the user is in distress and motionless, versus a non-emergency situation. In a non-emergency situation the user can cancel the alarm.

It, in the current art, is normal to take 30 seconds of motionless before the Full-Alarm Mode is activated. Upon such activation, any combination of auditory, vibratory and/or Radio Frequency alarming may become active. In situations where the motionless user is not breathing this is too much time as time is of the essence where every second counts.

There remains room for improvement in the current art.

### SUMMARY OF THE INVENTION

The current invention is relates to a Self-Contained-Breathing-Apparatus (SCBA) emergency situation where the user is motionless and non-breathing. In order to hasten a Full Alarm activation and speed up the notification of distress to rescuers, in addition to the standard motion-sensing alarm, the SCBA shall be equipped with an ‘air activation’ alarm. The ‘air activation’ alarm will monitor airflow from the regulator and activate if a user is not breathing for a certain amount of time, such as seven seconds.

The purpose of this invention is to acknowledge the especially critical situation of a non-breathing SCBA user. In such situations, every second is critical to the survival and brain function of the user.

Motionlessness may be an emergency event or not. The user may simply be remaining still and not in any distress. This is why a sufficiently long period of time is utilized, and pre-alarm is available, before a Full Alarm signal is activated. For the non-breathing user, the situation is always critical; there is no situation of non-distress that accompanies non-breathing. In such situations, the very life of the user depends upon the fastest response and rescue.

### BRIEF DESCRIPTION OF DRAWINGS

Without restricting the full scope of this invention, the preferred form of this invention is illustrated in the following drawings in which:

FIG. 1 is a view of a standard Self-Contained-Breathing-Apparatus (SCBA);

FIG. 2 is a view of the regulator and manual alarm;

FIG. 3 is a view of the remote console;

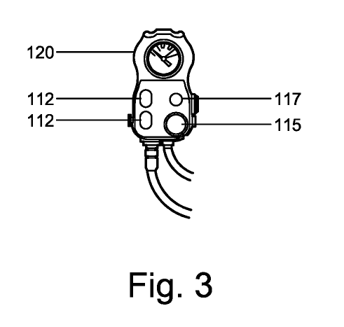

FIG. 4 is a view of the air flow sensor;

FIG. 5 shows the device with a wireless and GPS system.

### DETAILED DESCRIPTION OF THE PREFERRED EMBODIMENT

There are a number of significant design features and improvements incorporated within the invention.

This invention relates to a Self-Contained-Breathing-Apparatus (SCBA) 1 emergency situation where the user is motionless and non-breathing. The purpose of this invention is to acknowledge the especially critical situation of a non-breathing SCBA user. In such situations, every second is critical to the survival and brain function of the user.

In the industry, most SCBA are equipped with a motion sensing alarm mechanism 100 which constantly monitors movement, or lack thereof. A prolonged period without motion could be an indicative of a user in distress. Such alarming mechanisms will usually function by producing some kind of pre-alarm warning, after a set amount of motionlessness for which the user can move and discontinue the sequence. Such alarming mechanism will go into a ‘Full Alarm’ mode if the user has not moved during the pre-alarm cycle. This is to account for a legitimate Alarm activation, such as where the user is in distress and motionless, versus a non-emergency situation. In a non-emergency situation the user can cancel the alarm.

But the current art does not address the issue of the especially critical situation of a non-breathing SCBA user. In such situations, every second is critical to survival.

For the non-breathing user, the situation is always critical—there is no situation of non-distress that accompanies non-breathing. In such situations, the very life of the user depends upon the fastest response and rescue. This invention describes just such a mechanism for rapid alarming, response and rescue.

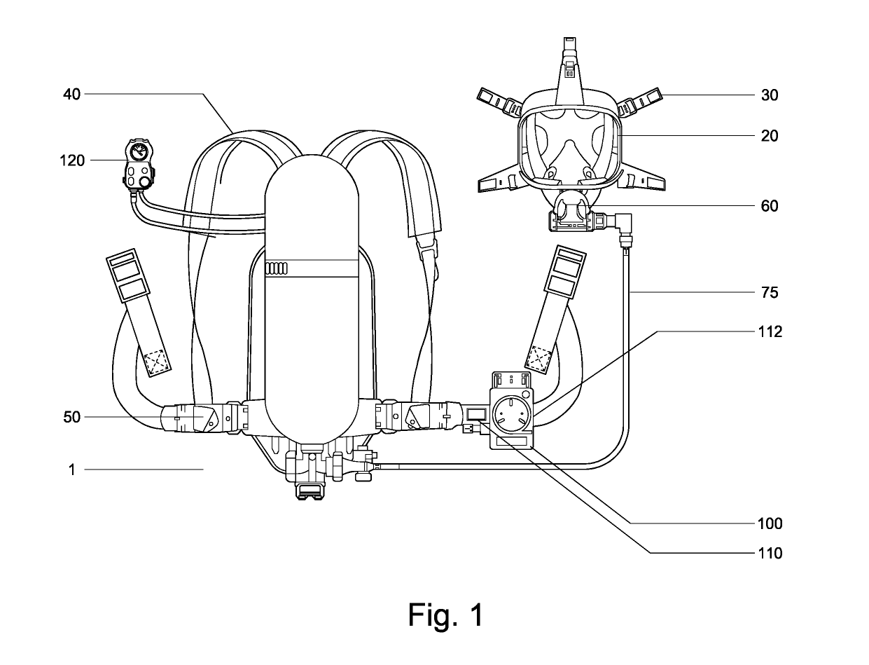

The current invention is a Self-Contained-Breathing-Apparatus (SCBA) with air activation alarm 10 and is shown in FIG. 1.

The Non-Breathing alarm 10 may utilize the same alarming mechanism as that for motionlessness alarm 100, or be wholly different. The Non-Breathing state may be assessed by any of the following mechanisms or combination thereof or wholly different methodology: Assessing the flow or lack thereof of air through the regulator or a certain section or part of the SCBA; The SCBA can use chips, microprocessors or other electronic means to ascertain airflow or lack thereof through the regulator or certain sections or parts of the SCBA. It can also use a mechanical means to assess airflow or lack thereof through the regulator or certain sections or part of the SCBA; any other mechanism through which airflow or lack thereof may be assessed.

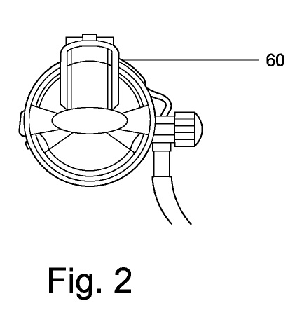

As shown in FIG. 1, the main components of the SCBA 1 are a face piece 20, a head net 30 which holds the face piece 20 on the user's head, shoulder straps 40 which go around the shoulders to hold the SCBA on a user's body, a waist belt 50 going around a user's waist. A regulator 60 is attached to the face piece 20 with a low pressure hose 75 going from the regulator 60. An example of a regulator 60 is shown in FIG. 2. The regulator 60 will have an inhalation valve 65 which opens when a user takes a breath.

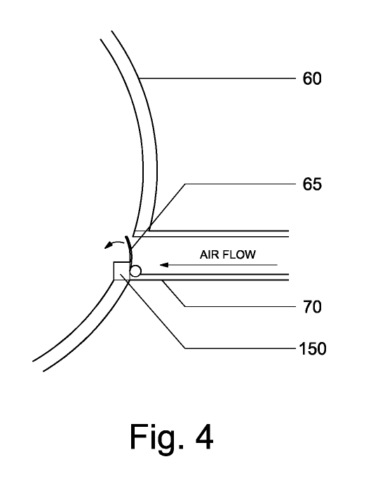

The SCBA 1 has a motion sensing alarm mechanism 100 which will sound an alarm if the user does not move for a set period of time, which is normally 30 seconds. There is a manual alarm button 115 which the user can activate if needed as well as an alarm turn off 117 on the remote console 120 as shown in FIG. 4. There is a power source for the electronic components of the SCBA such as the remote console 120 and alarms, which in the preferred embodiment would be a DC battery source. In the preferred embodiment, there are two lights 112 on the back of the Alarm 100 called buddy lights that flash one color in normal mode and another color in Alarm mode; usually green and red.

In the ‘sensing’ mode, the Alarm 100 constantly monitors motion of the SCBA back frame. The motion sensor is located in the sensor module along with the audible alarm. If the sensor module does not sense motion of the SCBA for a set amount of time, normally 20 seconds, the alarm 100 will signal a pre-alarm condition. If there is still no motion of the SCBA for the next set amount of time, normally 10 seconds, the alarm 100 will sound.

The current NFPA standard calls for an audible alarm with a variable pitch that helps eliminate audible alarm saturation. It allows for an easier way to hone in on the audible alarm and reduces reflective alarm sound. When a pre-alarm occurs, the ‘Normal’ flashing light on the control console is replaced by an ‘Alarm’ light which flashes approximately once per second and is accompanied by an ascending /descending audible alarm that increases in decibels during the pre-alarm cycle. A green flashing can be used as “Normal” with a red flashing light being used as “Alarm” but any color or lighting can be used.

If a user requires immediate assistance, the alarm 100 provides a manual alarm button located on the front of the control console 120.

A pre-alarm may also be reset by pressing and holding a reset button or another reset method may be used.

In order to hasten the Full-Alarm activation and speed up the notification of distress to rescuers, in addition to the standard motion sensing alarm sound, the current invention has the SCBA equipped with an ‘air activation’ alarm 10. Such ‘air activation’ alarm 10 shall monitor airflow and activate if a user is not breathing for a certain amount of time, say seven seconds. The air activation alarm 10 will be connected to remote console 120 and use some of the same alarm 100 functions and utilities such as the lights and audible alarms. A different sound and volume audible alarm may be used to signify the severity of the situation.

The air activation alarm 10 will immediately be activated if the air flow sensor 150 detects a lack of air flow out of the regulator 60 and/or face piece 20. In the preferred embodiment the air flow sensor 150 will be part of the regulator 60 and connected to the remote console 120 as shown in FIG. 4. The air flow sensor 150 can be connected anywhere where it can measure the air flow to and from the mask such as the low pressure hose 70. The air flow sensor 150 can be electronic or mechanical.

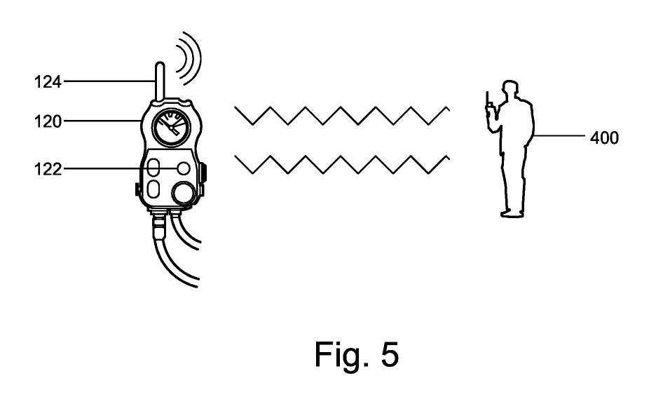

Due to the seriousness of the situation of when a user stops breathing, the SCBA 1 can have one or both of a wireless communication system 124 and a GPS system 122. In the preferred embodiment, these will be in the remote console 102, they may reside in the alarm 100 as well.. The wireless system will alert Incident Commanders 400 of the immediate need of rescuing a user who stopped breathing while the GPS system will relay where to find the distressed user and act as a tracking signal. This is shown in FIG. 5.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur by those skilled in the art, it is not desired to limit the invention to the exact construction and operation shown and described, and accordingly, all suitable modifications and equivalents may be resorted to, falling within the scope of the invention.

I claim:

1. A Self-Contained-Breathing-Apparatus (SCBA) device comprising:
a face piece with a regulator attached, a hose connecting the regulator to a plurality of air cylinders with an air flow sensor that measures the air flow from the regulator with the air flow sensor activating an alarm if the air flow rate falls below a set threshold or stops for a set period of time.

2. A device according to claim 1 where the power source for the air flow sensor is the same as for the other electronic components of the SCBA.

3. A device according to claim 1 where the air flow sensor monitors the movement or activation of the inhalation valve of the regulator

4. A device according to claim 1 having a Remote Console.

5. A device according to claim 4 where the Remote Console contains audible and visual alarming components.

6. A device according to claim 1 further comprising having the activation alarm being connected to remote console.

7. A device according to claim 1 further comprising having the activation alarm being connected to the Main Alarm.

8. A device according to claim 1 further comprising having the activation alarm being audible and visual.

9. A device according to claim 1 further comprising having the activation alarm being Radio Frequency, Bluetooth, RFID or Near Field communications.

10. A device according to claim 1 where the air flow sensor senses air or lack thereof into and or out of the facepiece.

11. A device according to claim 1 where the air flow sensor senses the flow of air or lack therof through the hose.

12. A device according to claim 1 where the air flow sensor electronically senses the flow of air or lack thereof.

13. A device according to claim 1 where the air flow sensor mechanically senses the flow of air or lack thereof.

14. A device according to claim 1 further comprising having the air flow sensor being in the regulator.

15. A device according to claim 4 further comprising having a manual alarm button on the remote console.

16. A device according to claim 4 further comprising the remote console having a GPS system with wireless communication.

17. A device according to claim 10 further comprising the motion sensing component having a GPS system with wireless communication.

18. A device according to claim 1 further comprising having a plurality of lights that light or flash to distinguish normal mode and alarm mode.

19. A device according to claim 1 further comprising the SCBA having a power source.

20. A Self-Contained-Breathing-Apparatus (SCBA) device comprising:
a face piece with a regulator attached, a hose connecting the regulator to a plurality of air cylinders with belts and shoulder straps to attach the device to the user, a remote console, a motion sensor sensing alarm mechanism which will sound an alarm if the user does not move for a set period of time, an air flow sensor that measures the air flow from the regulator and/or face piece, with the air flow sensor activating an activation alarm if the air flow falls below a set threshold or stops for a set period of time and a manual alarm button, where the alarms are audible and visual and having a plurality of lights that light or flash to distinguish normal mode and alarm mode.
